(19) United States
(12) Patent Application Publication
(10) Pub. No.: US 2007/0291906 A1
(43) Pub. Date: Dec. 20, 2007

(54) A Test System and Method of Operation

(75) Inventors: David J. Halliday, West Leake (GB); Steve J. Lakin, Donisthorpe (GB)

Correspondence Address: MOTOROLA, INC., LAW DEPARTMENT, 1303 E. ALGONQUIN ROAD, SCHAUMBURG, IL, 60196, US

(73) Assignee: MOTOROLA, INC., Schaumburg, IL (US)

(21) Appl. No.: 11/424,460

(22) Filed: Jun. 15, 2006

(51) Int. Cl. H04M 1/24; H04M 3/08; H04M 3/22

(52) U.S. Cl. 379/1.01

(57) ABSTRACT

A test system comprises a test processor which determines an operational status, such as a fault status, for a unit under test. The unit under test may e.g. comprise one or more boards of an electronic assembly. A presence processor generates a presence message in response to the operational status where the presence message is in accordance with a user presence message protocol. A communication controller then transmits the presence message to a remote network element of a communication network. The remote network element may be a presence server which can transmit a presence status update to associated devices. The invention may allow efficient and remote status monitoring for a test system using user presence infrastructure.

### FIELD OF THE INVENTION

The invention relates to a test system and method of operation and in particular, but not exclusively, to hardware level testing of electronic assemblies.

### BACKGROUND OF THE INVENTION

In order to facilitate and reduce the cost of implementation of complex electronic equipment, there is an increasing drive towards interoperability between different manufacturers. Furthermore, testability of electronic assemblies is becoming increasingly important in order to ensure high reliability and early fault detection.

Specifically, in order to facilitate implementation of hardware for telecommunication applications, the PCI Industrial Computer Manufacturers Group (PICMG™) has developed hardware standards known as Telecom Computing Architecture (TCA) standards. The standards define a number of parameters such as mechanical features (e.g. rack size, board size), electrical features (e.g. supply voltages, max power consumptions) and interworking features (e.g. backplane communication characteristics) which allow standard hardware modules and elements from different vendors to be used together. Specifically, the MicroTCA standard has been developed to provide a flexible and efficient interworking for smaller modules with lower power consumptions.

In order to provide improved testability, a number of test methods and procedures have also been standardised. For example, TCA systems often implement support for boundary scan/JTAG (Joint Test Action Group) testability for preferably both in-deployment (e.g. customer accessible) and for manufacturer test purposes. Such test functionality allows detailed hardware level tests to be performed to verify the operation of the system.

TCA test systems typically provide an interface to an external test station that can to control the performed testing and interpret the obtained test results. For example, an RS232 port may be provided for coupling an external laptop computer to the test system. The laptop computer then executes a dedicated and vendor specific test program which interprets the test results and presents the health status of the equipment to a test operator.

However, such an approach tends to be inflexible and provide a limited user experience. Specifically, prior art approaches tend to require dedicated test and/or vendor specific software to be executed in order to evaluate the test results. Furthermore, the test results are either interpreted locally or complex functionality is used to communicate the test results to remote stations for processing.

Hence, an improved system would be advantageous and in particular a system allowing increased flexibility, reduced complexity, reduced cost, improved status reporting, reduced need for dedicated and/or vendor specific functionality and/or improved user friendliness would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided a test system comprising: a test processor arranged to determine an operational status for a unit under test; a presence agent arranged to generate a presence message in response to the operational status, the presence message being in accordance with a user presence message protocol; and a communication controller arranged to transmit the presence message to a remote network element of a communication network.

The invention may allow an improved test system. In particular, the invention may allow an improved presentation and/or reporting of an operational status of a unit under test. The invention may allow facilitated remote reporting and/or presentation utilizing e.g. already existing human interaction presence systems. The invention may allow an increased use of standard equipment to report and/or present an operational status of the unit under test. Specifically, the invention may obviate or reduce the requirement for dedicated and/or vendor specific test evaluation hardware and/or software.

The unit under test may for example be a TCA assembly and/or may be e.g. one or more blades, modules, boards and/or subsystems of a TCA assembly. The user presence message protocol may be a protocol of a user presence system supporting user presence indications in a communication system, such as e.g. the Internet and/or a cellular communication system.

The presence agent may be any functionality arranged to generate a presence message in response to the operational status, such as e.g. a firmware/software routine and/or a software client of a presence system.

According to an optional feature of the invention, the remote network element comprises a user presence server arranged to transmit a presence indication representing the operational status to at least one destination device.

This may allow efficient operation and/or reduce complexity in many embodiments. For example, the user presence server may be an instant messaging server already implemented to provide an instant messaging/presence service for users of the communication system. Such a user presence server may synergistically be used to provide health status reporting for e.g. electronic hardware assemblies.

According to an optional feature of the invention, the test system further comprises: a receiver arranged to receive an instant message from the instant message server, the instant message comprising at least one test instruction; and a test controller arranged to control at least one test procedure in response to the at least one test instruction.

This feature may provide efficient and/or low complexity functionality for allowing remote control of the test operation.

According to another aspect of the invention, there is provided a communication system comprising a test system comprising: a test processor arranged to determine an operational status for a unit under test, a presence agent arranged to generate a presence message in response to the operational status, the presence message being in accordance with a user presence message protocol, and a communication controller arranged to transmit the presence message to a user presence server; and the user presence server comprising: a controller for determining at least one destination device associated with the test system, and a distribution controller arranged to communicate a presence indication message comprising an indication of the operational status to the destination device.

According to another aspect of the invention, there is provided a method of operation for a test system, the method comprising: determining an operational status for a unit under test; generating a presence message in response to the operational status, the presence message being in accordance with a user presence message protocol; and transmitting the presence message to a remote network element of a communication network.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates a test system in accordance with some embodiments of the invention;

FIG. 2 illustrates a communication system in accordance with some embodiments of the invention;

FIG. 3 illustrates an example of a health status presentation for a system in accordance with some embodiments of the invention; and

FIG. 4 illustrates an example of a method of operation for a test system in accordance with some embodiments of the invention.

### DETAILED DESCRIPTION OF SOME EMBODIMENTS OF THE INVENTION

The following description focuses on embodiments of the invention applicable to health monitoring and test reporting for a TCA hardware assembly. However, it will be appreciated that the invention is not limited to this application but may be applied to many other systems.

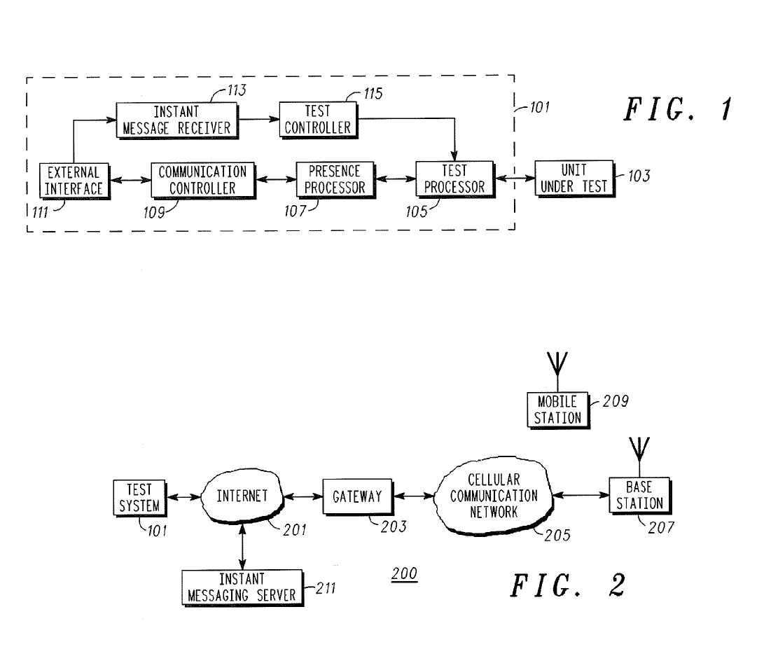

FIG. 1 illustrates a test system 101 in accordance with some embodiments of the invention. The test system 101 is in the specific example part of a TCA hardware assembly and is arranged to perform tests of subsystems of the TCA assembly such as of individual or groups of mezzanine cards, modules or blades.

In FIG. 1 a unit under test 103 is coupled to the test system 101 for testing. Although FIG. 1 illustrates only a single unit under test 103, it will be appreciated that the test system may be arranged to test a plurality of different modules, cards subsystems etc. Specifically, in different embodiments, the unit under test 103 may be considered to correspond to a single hardware element (e.g. a card, module or blade), a plurality of hardware elements or all hardware elements of the TCA assembly.

Specifically, the unit under test 103 is coupled to a test processor 105 of the test system 101 through a Joint Test Action Group (JTAG) interface connection.

The test processor 105 comprises functionality for performing various test operations on the unit under test 103. Specifically, the test processor 105 can perform JTAG test operations on the unit under test 103 in accordance with the IEEE standard no. 1149.1 “Standard Test Access Port and Boundary-Scan Architecture” defined by the Joint Test Action Group. This test approach allows detailed hardware level testing including boundary scan testing, programmable device upgrades and fault insertion testing. Boundary scan testing is typically performed at the time of board assembly but can also be performed in-deployment.

Thus, in the example of FIG. 1, the unit under test 103 is coupled to the test processor 105 through one or more JTAG connections. Each JTAG connection comprises four or five interface lines for clock and data signals as will be known to the person skilled in the art. Furthermore, the test processor 105 comprises a Test Access Port (TAP) controller which can perform the boundary (etc) tests on the unit under test. It will be appreciated that the test processor 105 may be arranged to include a separate TAP controller functionality for each JTAG connection allowing e.g. parallel or sequential test of a plurality of different subsystems or modules.

The test processor 105 can specifically determine an operational status of the unit under test 103. Thus, the test processor 105 can perform tests, such as boundary scan tests, on the unit under test 103 to determine an operational status.

In a simple embodiment, the operational status may simply correspond to a binary fault status for each of the subsystems or modules. For example, the test processor 105 can sequentially perform a boundary scan test of each module of the TCA assembly. If the boundary scan test for a given module indicates that the module is operating correctly, the fault status indication for this module is set to indicate a fault free status. However, if the boundary scan test detects a fault, the fault status indication is set to indicate a faulty status.

A fault status indication for the whole TCA assembly can be generated by combining the fault status indications for each of the tested modules into a single fault status indication. This combined fault status indication can include the individual indications thereby allowing an identification of each individual faulty module or may additionally or alternatively comprise a single status indication for the whole TCA assembly. For example, a simple OR or AND operation may be used to generate a total fault status indication which indicates a fault free status only if all the fault status indications of the individual modules indicate a fault free status.

It will be appreciated that in other embodiments, other and more complex operational status indications may be used. For example, a more detailed fault status indication may include an indication of the nature of the fault. Also, it will be appreciated that the operational status is not necessarily a fault status indication but may additionally or alternatively be a status indication for e.g. one or more current operational parameters or characteristics. For example, the generated status indication can reflect a current mode of operation for each module and/or current electrical characteristics, such as e.g. a current power consumption or temperature a level.

The test processor 105 is coupled to a presence processor 107 which comprises a presence agent that is arranged to generate a presence message in response to the operational status indication received from the test processor 105. The presence agent can for example be a software or firmware routine and/or hardware logic such as field programmable logic. However, it will be appreciated that any means of implementing the function of generating a presence message in response to the operational status can be used.

The presence processor 107 is coupled to a communication controller 109 which is arranged to transmit the presence message to a remote network element of a communication network. Specifically, the communication controller 109 is coupled to an external interface 111 which interfaces to an external network.

Thus, the test system 101 can determine an operational status for the unit under test 103 and can generate a presence message which reflects the determined operational status. The presence message can then be communicated to an external monitoring device using existing user presence systems. This may allow an efficient communication of status information while allowing a high degree of reusability of existing network infrastructure and functionality as well as a possible reuse of standard devices.

The presence message which is generated by the presence processor 107 is specifically generated to comply with a user presence message protocol. Thus, the presence message generated by the test system can, possibly apart from the payload data, be indistinguishable from a presence message used to indicate a user presence. Hence, the test system 101 can effectively disguise itself as a user and may for the presence infrastructure be indistinguishable from a presence agent operated for a human user.

In a presence system, presence information is typically generated by software routines associated with the communication system users to convey a presentity's availability and willingness to communicate. An agent software routine (such as e.g. a presence client routine) publishes presence information to other systems' users—sometimes called watchers or subscribers—to convey its communication state. Presence information has wide application in voice over IP and instant messaging where it is used to further provide communication assistance by providing a real time indication of a user's availability to other users.

In many communication systems, infrastructure has been developed and deployed to support presence information and thereby to provide an enhanced communication experience to the individual user. The test system 101 of FIG. 1 allows such infrastructure to additionally be used for hardware status monitoring. The system 101 can specifically behave like any other presence agent for a communication user thereby allowing the existing presence infrastructure and/or devices to be reused for status monitoring without any modifications being necessary.

In some embodiments, the external interface 111 may be able to communicate directly with a monitoring device. For example, the external interface 111 may comprise a WiFi™ transceiver which can transmit the user presence message directly to a monitoring device also comprising a WiFi™ transceiver. However, in contrast to conventional monitoring systems which use dedicated and vendor specific functionality for status reporting, the monitoring device can in this example fully or partially reuse functionality developed in support of a presence service. Thus, the approach may allow a standard device with no dedicated status reporting functionality to be used to present the determined operational status for the unit under test 103.

Alternatively or additionally, the test system 101 of FIG. 1 can be used for efficient status reporting within a more complex communication system. For example, the test system 101 can exploit existing presence systems of for example the Internet and/or cellular communication systems to provide an efficient way of providing status reports to remote devices.

FIG. 2 illustrates a communication system 200 in accordance with some embodiments of the invention. In the example a presence and instant messaging system of the Internet and a cellular communication system is used by the test system 101 to provide substantially real time status reporting to a low cost mobile station.

In the communication system 200 the test system 101 is coupled to the Internet 201. Thus, the external interface 111 comprises an interface to the Internet 201.

The Internet 201 is coupled to a Gateway 203 that provides an interworking function between the Internet 201 and a cellular communication network 205 which may for example be a GSM or UMTS cellular communication system. The cellular communication network 205 is specifically coupled to a base station 207 which is arranged to communicate with remote stations over the air interface of the cellular communication system. Specifically, the base station 207 can communicate with a mobile station 209 over the air interface.

In the example, the test system 101 uses a presence and instant messaging service of the Internet to provide status reporting to the mobile station 209. Specifically, the Internet 201 is coupled to an instant messaging server 211 which also comprises a presence server.

Instant messaging is generally used for instant (real time) message communication between two or more people over a network such as the Internet. Instant messaging can for example be based on text messages and examples of instant messaging services include MSN Messenger and Skype™ messaging. Recently, many instant messaging services have begun to offer video conferencing features, Voice over IP (VoIP) and web conferencing services.

Instant messaging typically boosts communication and allows easy collaboration. In contrast to e-mails or conventional telephone systems, presence functionality is typically included to let the parties know whether the peer is available. Most systems allow the user to set an online status or away message so peers get notified whenever the user is available, busy, or away from the computer. On the other hand, people are not forced to reply immediately to incoming messages.

In a typical presence system, a presence user agent (or presentity) logs online/offline status with a centralized presence server such as that included in the instant messaging server 211. A watcher can subscribe with the presence server to be notified of state changes i.e. the user coming online, going offline etc.

In the system of FIG. 2, a similar approach is used by the test system 101 to generate and disseminate equipment status information. In the specific example, the test system communicates with the instant messaging server 211 using a Session Initiation Protocol (SIP) and in particular using a SIMPLE (Session Initiation Protocol for Instant Messaging and Presence Leveraging Extensions) protocol. SIMPLE is an instant messaging protocol which applies SIP to the problems of:
Registering for presence information and receiving notifications.
Managing a session of real-time messages between two or more participants.

Specifically, the test processor 105 can perform a boundary scan test of the unit under test 103 at regular intervals.

The fault status determined from the test is then fed to the presence processor 107 which detects if any change has occurred since the previous test was performed. If no change has been identified since the last user presence message was transmitted to the instant messaging server 211, the presence processor 107 ignores the status indication and does not take any further action. However, if the presence processor 107 detects that a change has occurred in the status indication, it proceeds to generate a new user presence message. For example, if the boundary scan test detects a previously undetected fault on one of the modules of the TCA assembly, a new presence message is generated.

The presence processor 107 specifically encapsulates status data into a standardized SIMPLE message which is fed to the communication controller 109. The communication controller 109 then transmits the message to the instant messaging server 211 using the standard SIP and IP protocols. Specifically, the status update can be communicated in a SIP NOTIFY message as defined in RFC 3265.

The instant messaging server 211 receives the status update message from the test system 101. The message may for the instant messaging server 211 be indistinguishable from a standard user presence message and can be processed like a conventional user presence message.

Specifically, the instant messaging server 211 can comprise a processor which determines which monitoring devices are associated with the identity of the test system 101. Thus, this controller determines the identity of the watchers that are authorised to receive a presence status update for the test system 101.

The instant messaging server 211 furthermore comprises a distribution controller which then transmits a presence indication message to the identified device(s). The communication of this message to the destination device is also achieved using standard SIP and SIMPLE mechanisms.

In a specific example, when the instant messaging server 211 receives a presence message from the test system 101 it identifies the mobile station 201 as an authorised watcher for the test system 101. Accordingly, it encapsulates the payload data of the received presence message in a new presence indication message which is transmitted to the mobile station 209 via the Internet 201, the Gateway 203, the cellular communication network 205 and the base station 207. The presence indication message can specifically be a SIP NOTIFY message as defined in RFC 3265.

When the mobile station 209 receives the present indication message from the instant messaging server 211 it proceeds to extract the status information and to present this to the user in a suitable format. For example, the mobile station 209 can present the status information on a display of the mobile station.

Thus, the system of FIG. 2 provides efficient distribution of test result and status information from a hardware level test system. Specifically, the system allows the test system (or the unit under test) to take on an identity in the manner of a person in an instant messaging/user presence system. The system thereby allows test and status data to integrate into a format that can be displayed on e.g. new mobile phone technology hence obviating the need for specific terminals or bulky test equipment to monitor and be notified of machine health status, and to be alerted of e.g. specific platform or sub-platform failures/issues.

Furthermore, by building on the IETF SIP and SIMPLE standards, it is relatively straightforward to implement a system that allows the test system 101 to be added as a presence entity, such as an instant messaging contact. This may e.g. allow a remote test operator to be alerted of state changes on a regular mobile handset.

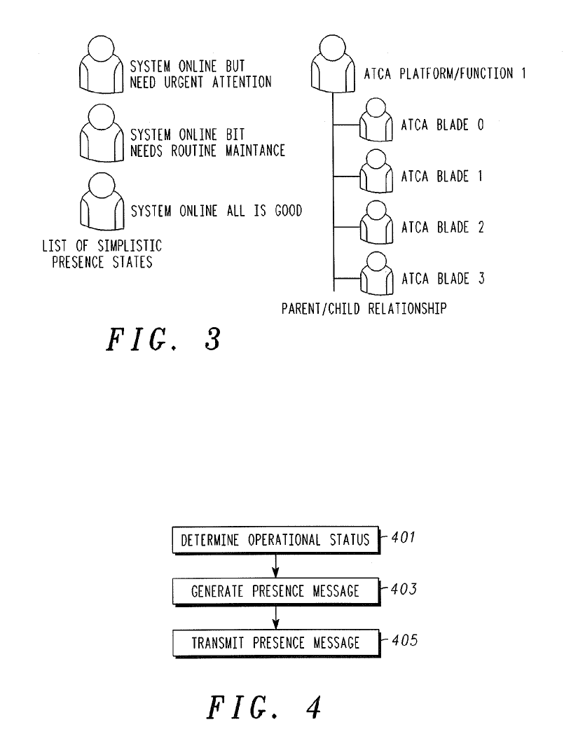

The approach may e.g. provide a user friendly graphical representation of the individual elements of a TCA assembly or platform. The visual representation may furthermore be arranged such that it provides an easy visual representation of the platform (or assembly) components in a manner that is easy to comprehend on small hand held devices such as a regular mobile phone size display. FIG. 3 illustrates an example of a visual representation for an Advanced TCA (ATCA) platform comprising a number of blades (cards). The example illustrates how the status of the individual blades can be represented together with a status of the platform as a whole. The example furthermore illustrates how the parent/child relationship between the different elements can be effectively presented.

The described functionality can be implemented using low-complexity and low cost approaches. Specifically, very low cost devices supporting the SIP, TCP and IP protocols are available and can be used in the test system 101.

The described system allows anyone with presence capability on a fixed/mobile device (with appropriate access rights) to monitor the health of deployed equipment anywhere using a simple and general purpose terminal such as a small mobile terminal (e.g, a Personal Digital Assistant (PDA) or a mobile phone).

It will be appreciated that in some embodiments, the presence processor 107 can include data in the presence message which is specific to the test system. This data can be forwarded to the monitoring device which can comprise dedicated functionality for extracting this data and for presenting it to the user of a suitable fashion.

However, in other embodiments the presence message generated by the test system 101 can comprise a presence indication which refers to a user rather than to a hardware element. In this case, a standard device may be used to monitor the health of the unit under test 103 by the device interpreting the presence indication from the test system 101 as relating to a user. For example, the test system 101 may simply generate a presence message which indicates whether the system is online or offline. A standard user presence device receiving such a message can simply indicate whether a virtual user associated with the test system identity is offline or online. This can be interpreted by a test operator to indicate whether the test system is online corresponding to a normal fault free operation or whether it is offline corresponding to a fault being present. Thus, a user related indication can be used to provide status information for a hardware system.

In such a system, the presence processor 107 may simply select the presence indication for the presence message from a predetermined set of presence indications where each of the presence indications corresponds to a user presence indication. In the specific example, the set of presence indications thus comprise an offline presence indication and an offline presence indication.

The test system 101 of FIG. 1 furthermore comprises an instant message receiver 113 which is coupled to the external interface 111. The instant message receiver 113 can receive instant messages from the instant messaging server 211. For example, the mobile station 209 can transmit an instant message to the test system 101 via the instant messaging server 211.

The received instant messages are fed from the instant message receiver 113 to a test controller 115 which is furthermore coupled to the test processor 105. The test controller 115 can control the test operations performed by the test processor 105 in response to the received instant messages. For example, a user of the mobile station 209 may generate an instant message which instructs the test system 101 to perform a specific test. When this message is received by the test controller 115 it instructs the test processor 105 to begin the specified test.

Thus, the system of FIG. 2 also allows for an efficient and easy to implement approach to providing remote control of the test system 101. For example, instant messaging can provide easy textual interaction with a presentity e.g. allowing tests to be invoked with the platform functions via a keyboard interface.

FIG. 4 illustrates an example of a method of operation for a test system in accordance with some embodiments of the invention.

The method initiates in step 401 wherein an operational status is determined for a unit under test.

Step 401 is followed by step 403 wherein a presence message is generated in response to the operational status. The presence message is in accordance with a user presence message protocol.

Step 403 is followed by step 405 wherein the presence message is transmitted to a remote network element of a communication network.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. A test system comprising:
a test processor arranged to determine an operational status for a unit under test;
a presence agent arranged to generate a presence message in response to the operational status, the presence message being in accordance with a user presence message protocol; and
a communication controller arranged to transmit the presence message to a remote network element of a communication network.

2. The test system of claim 1 wherein the remote network element comprises a user presence server arranged to transmit a presence indication representing the operational status to at least one destination device.

3. The test system of claim 2 wherein the remote network element comprises an instant messaging server.

4. The test system of claim 3 further comprising:
a receiver arranged to receive an instant message from the instant message server, the instant message comprising at least one test instruction; and
a test controller arranged to control at least one test procedure in response to the at least one test instruction.

5. The test system of claim 1 wherein the presence agent is arranged to encapsulate an indication of the operational status in a user presence status message.

6. The test system of claim 1 wherein the test processor is arranged to detect a change in the operational status;
and the presence agent is arranged to generate a new presence message in response to the change in the operational status.

7. The test system of claim 1 wherein the communication controller is arranged to communicate in accordance with a Session Initiation Protocol, SIP.

8. The test system of claim 7 wherein the communication controller is arranged to communicate in accordance with a SIP for Instant Messaging and Presence Leveraging Extensions, SIMPLE, protocol.

8. The test system of claim 1 wherein the operational status is a fault status.

9. The test system of claim 1 wherein the operational status comprises operational status indications for a plurality of subsystems of the unit under test.

10. The test system of claim 1 wherein the presence agent is arranged to select a present indication for the presence message between a set of presence indications in response to the operational status, each of the set of presence indications corresponding to a user presence indication.

11. The test system of claim 1 wherein the test processor comprises:
a boundary scan test module arranged to perform a boundary scan test of the unit under test; and
a determination processor arranged to determine the operational status in response to the boundary test scan.

12. The test system of claim 1 wherein the communication network comprises a cellular communication system.

13. The test system of claim 1 wherein the communication network comprises an Internet.

14. A communication system comprising:
a test system comprising:
a test processor arranged to determine an operational status for a unit under test,
a presence agent arranged to generate a presence message in response to the operational status, the presence message being in accordance with a user presence message protocol, and
a communication controller arranged to transmit the presence message to a user presence server; and
the user presence server comprising:
a controller for determining at least one destination device associated with the test system, and
a distribution controller arranged to communicate a presence indication message comprising an indication of the operational status to the destination device.

15. The communication system of claim 14 comprising the destination device and wherein the destination device comprises:
a receiver for receiving the presence indication message from the user presence server; and
a presentation controller for presenting the indication of the operational status to a user of the destination device.

16. The communication system of claim 14 wherein the destination device is a mobile terminal.

17. A method of operation for a test system, the method comprising:
determining an operational status for a unit under test;
generating a presence message in response to the operational status, the presence message being in accordance with a user presence message protocol; and
transmitting the presence message to a remote network element of a communication network.
